(19) United States
(12) Patent Application Publication
(10) Pub. No.: US 2024/0061140 A1
(43) Pub. Date: Feb. 22, 2024

(54) DETERMINATION OF GEOLOGIC PERMEABILITY CORRELATIVE WITH MAGNETIC PERMEABILITY MEASURED IN-SITU

(71) Applicant: Saudi Arabian Oil Company, Dhahran (SA)

(72) Inventors: Val Riachentsev, Katy, TX (US); Robert Adams, Fulshear, TX (US); Max Deffenbaugh, Fulshear, TX (US); Howard K. Schmidt, Dhahran (SA)

(21) Appl. No.: 18/494,292

(22) Filed: Oct. 25, 2023

Related U.S. Application Data
(62) Division of application No. 16/988,434, filed on Aug. 7, 2020, now Pat. No. 11,835,675.
(60) Provisional application No. 62/884,071, filed on Aug. 7, 2019.

(51) Int. Cl. G01V 3/28; E21B 47/113; E21B 47/06; E21B 49/08; G01V 3/30

(52) U.S. Cl. CPC G01V 3/28; E21B 47/113; E21B 47/06; E21B 49/08; G01V 3/30; E21B 49/008

(57) ABSTRACT

The present device and technique relates to measuring geological formation permeability, such as by injection/withdrawal of conductivity-permeability doped fluid and measuring the magnetic permeability and/or conductivity of the surrounding formation. Before, during and/or after injection or withdrawal, pluralities of electromagnetic measurements of the radial distribution of magnetic permeability and/or conductivity of the surrounding formation may be made. The rate of change of the radial distribution of magnetic permeability and/or conductivity of the formation is generally directly proportional to the permeability of the surrounding formation. In implementations, magnetic permeability and electrical conductivity can be measured independently in time domain or frequency domain, such that the magnetic permeability mapping is not disturbed by other confounding electromagnetic parameters.

### CROSS-REFERENCE TO RELATED APPLICATION

This application is a divisional of U.S. patent application Ser. No. 16/988,434, filed Aug. 7, 2020, which claims the benefit of priority to U.S. Provisional Patent Application Ser. No. 62/884,071, filed Aug. 7, 2019, the contents of which are hereby incorporated by reference herein.

### TECHNICAL FIELD

This disclosure relates to the logging of oil and gas wells. Specifically, it is a method to determine the permeability of geological formations intersected by a wellbore.

### BACKGROUND

Permeability is a property of a porous medium that relates the flow rate to the applied pressure gradient. It is related to the size scale of the pore space within the medium and to its interconnectedness. The permeability of a subsurface rock formation, such as an oil or gas reservoir, controls the rate at which hydrocarbons can be produced and often determines whether producing oil and gas from a given reservoir will be profitable or not. When developing an oilfield, a computer model of the reservoir is used to simulate the subsurface movement of oil, gas and brine for different scenarios of where to locate wells, how quickly to produce from the wells, and where to inject other fluids to help sweep out the hydrocarbons. The accuracy of these computer model predictions depends primarily on how accurately the permeability throughout the reservoir is known, and where high permeability barriers to flow are found.

Despite their importance for optimizing oil and gas production, accurate measurements of permeability are difficult to obtain. The permeability of a reservoir rock is typically determined by laboratory measurements on samples of the rock which are recovered from the subsurface using a process called “coring”. After coring, the samples are transported to a laboratory and resaturated with a mixture of oil, gas, and brine similar to what was believed to be in the rock when it was part of the reservoir. Oil or brine are then pushed through the rock sample with a prescribed pressure gradient and the resulting flow rates are measured. This process is time-consuming and costly, and can be inaccurate. The selected rock samples may not be representative of the properties of the reservoir. The detailed distribution of hydrocarbons and brine within the pore space of the sample impacts the phase permeabilities for oil and brine, but cannot be accurately known or reconstructed in the laboratory. Furthermore, the wettability of the rock surface within the pore space impacts measured phase permeabilities and cannot be accurately reconstructed in the lab.

Accordingly, there is a need for a method of determining the permeability of reservoir rocks which samples larger rock volumes than the small samples (e.g., 1 inch to 6 inch) measured in the laboratory. A method should ideally make its measurements in the reservoir itself so that the fluid distributions and wettability will be correct and will not need to be reconstructed. This disclosure describes such a method and associated system and tool.

### SUMMARY

An aspect relates to a system to determine the phase permeabilities of a subsurface formation surrounding a borehole. The system includes 1) a fluid with an elevated magnetic permeability; 2) a means to inject the fluid into the subsurface formation; 3) a downhole tool capable of measuring the mutual inductance between pairs of inductive coils where the magnetic field of the coils extends beyond the borehole and into the formation; 4) a process for imaging the magnetic permeability of the formation near the borehole from the measurements of mutual inductance; 5) a process for relating the image of magnetic permeability near the borehole to the phase permeabilities of the formation.

Another aspect relates to a method to determine the permeability downhole of a geological formation surrounding a borehole. The method includes deploying a downhole tool into the borehole at a specific depth and measuring, via the downhole tool, a baseline radial profile of magnetic permeability of the geological formation around the downhole tool. The method includes injecting a fixed amount of magnetic-permeability doped fluid into the geological formation around the downhole tool. The method includes measuring, via the downhole tool, a post-injection radial profile of magnetic permeability of the geological formation around the downhole tool after injecting the fixed amount of magnetic-permeability doped fluid. The method includes comparing the baseline radial profile with the post-injection radial profile to determine a difference between the post-injection radial profile and the baseline radial profile. The method includes using the difference in magnetic permeability of the geological formation around the tool to determine the permeability of the formation.

Yet another aspect relates to a method to determine the permeability downhole of a formation surrounding a borehole. The method includes deploying a downhole tool into the borehole at a specific depth and injecting a fixed amount of magnetic-permeability doped fluid into the formation around the downhole tool. The method includes measuring, via the downhole tool, a post-injection radial profile of magnetic permeability of the formation around the downhole tool after injecting the fixed amount of magnetic-permeability doped fluid. The method includes withdrawing fluid from the formation and measuring, via the downhole tool, a post-production radial profile of magnetic permeability of the formation around the downhole tool after withdrawing a fixed amount of fluid from the formation. The method includes correlating a difference between the post-production radial profile and the post-injection radial profile with permeability of the formation around the downhole tool.

Yet another aspect relates to a system to determine permeability of a geological formation. The system includes a downhole tool to measure magnetic permeability of the geological formation. The system includes a pump to inject fluid having magnetic particles through a first wellbore into the geological formation. The system includes a vessel to receive fluid having magnetic particles withdrawn from the formation through a second wellbore.

Yet another aspect relates to a method including deploying a downhole tool into a wellbore in a geological formation and measuring, via the downhole tool, a baseline radial profile of magnetic permeability of the geological formation. The method includes injecting a fluid having magnetic particles into the geological formation. The method includes measuring, via the downhole tool, a post-injection radial profile of magnetic permeability of the geological formation after injecting the fluid having magnetic particles. The method includes comparing the baseline radial profile with the post-injection radial profile to determine permeability of the geological formation.

Yet another aspect relates to a method including deploying a downhole tool into a wellbore in a geological formation and injecting a fluid having magnetic particles into the geological formation. The method includes measuring, via the downhole tool, a post-injection radial profile of magnetic permeability of the formation after injecting the fluid having the magnetic particles. The method includes withdrawing a produced fluid having magnetic particles from the geological formation. The method includes measuring, via the downhole tool, a post-production radial profile of magnetic permeability of the geological formation after withdrawing the produced fluid having magnetic particles from the geological formation. The method includes correlating a difference between the post-production radial profile and the post-injection radial profile with permeability of the geological formation.

Yet another aspect relates to a method to determine permeability of a geological formation. The method includes deploying a downhole tool (having a transmitter coil) into a wellbore in the geological formation, the downhole tool comprising electronics to measure the self-inductance of said transmitter coil. The method includes injecting magnetic particles into the geological formation and measuring, via the downhole tool, magnetic permeability of the geological formation having the injected magnetic particles.

Yet another aspect relates to a method to determine permeability of a geological formation. The method includes lowering a downhole tool (having a transmitter and a receiver) into a wellbore in the formation. The method includes injecting magnetic particles through the wellbore into the formation, withdrawing the magnetic particles from the formation through the wellbore, and measuring magnetic permeability of the formation via the downhole tool during injecting the magnetic particles and during withdrawing the magnetic particles.

Yet another aspect relates to a downhole tool to determine permeability of a geological formation. The downhole tool includes a transmitter to emit a magnetic field into the geological formation. The downhole tool includes a receiver to sense the magnetic field for the downhole tool to measure magnetic permeability of the geological formation. The downhole tool includes an electronics module having a processor and memory storing code executable by the processor to facilitate operation of the downhole tool and to provide data of the measured magnetic permeability for determination of the permeability.

The details of one or more implementations are set forth in the accompanying drawings and the description to be presented. Other features and advantages will be apparent from the description and drawings, and from the claims.

### BRIEF DESCRIPTION OF DRAWINGS

FIG. 1 is a diagram of a well site including a system to measure permeability of a geological formation.

FIG. 2 is a block flow diagram of a method of determining permeability of a geological formation.

FIG. 3 is a block flow diagram of a method of determining permeability of a geological formation.

### DETAILED DESCRIPTION

The present application describes a method and apparatus for determining the phase permeability of a rock formation along a borehole. A fluid with elevated magnetic permeability is created by mixing particles of high magnetic permeability into a water-based or oil-based fluid. The fluid is injected into the formation around a borehole by applying a pressure in the borehole which exceeds the formation pressure by an excess pressure ΔP for a time duration ΔT. This excess pressure ΔP acting over time ΔT drives the injected fluid a distance ΔR into the formation, where ΔR depends on the phase permeability kᵢ of the formation to the injected phase, whether brine or oil. If ΔR is found, then kᵢ can be calculated. In one embodiment, ΔR is found by measuring the mutual inductance between pairs of solenoid coils around the axis of the tool and inverting for the value of ΔR which may best explain the measured mutual inductances. In one embodiment, ΔR is found by measuring the self-inductance of a solenoid coils around the axis of the tool and inverting for the value of ΔR which may best explain the measured self-inductance.

Permeability is a property of porous medium such as a reservoir rock which relates the flow rate through the rock to the pressure gradient that drives the flow. This relationship is expressed by Darcy's Law:

$$q = - \frac{k}{μ} ∇ p$$

where q is the flow rate per unit area, for example in units of m/s, μ is the dynamic viscosity of the fluid, for example in units of Pa·s, ∇p is the pressure drop over a given distance of the material in units of Pa/m, and k is the permeability of the material in units of m². Permeability is difficult to measure downhole. Such lack of measurement downhole can lead to inaccurate estimations of the economic capacity of a petroleum reservoir. In-situ downhole implementations of permeability measurements can be more reliable for quantifying reservoir behavior than via ex-situ measurements of permeability.

Permeability, which is also referred to as “absolute permeability” is a property of a porous medium where the pore space is filled with a single fluid. When the pore space is filled with more than one fluid, such as a mixture of oil and brine, then the flow of one fluid (e.g., oil) when it is injected with a given pressure drop can be different from the flow of another fluid (e.g., brine) when it is injected with the same pressure drop. For the ith fluid phase,

$${q}_{i} = - \frac{{k}_{i}}{{μ}_{i}} ∇ p$$

where qᵢ is the flow rate of the ith fluid phase per unit area, for example in units of m/s, μᵢ is the dynamic viscosity of the ith fluid phase, for example in units of Pa·s, ∇p is the pressure drop over a given distance of the material in units of Pa/m, and kᵢ is called the “phase permeability” of the medium to the ith fluid phase in units of m². The ratio of the phase permeability to the absolute permeability is the “relative permeability”. The relative permeability is defined as,

$${k}_{r , i} = \frac{{k}_{i}}{k}$$

The relative permeability has a value from 0 to 1 and describes the extent to which the other fluids in the pore space impede the flow of the ith fluid phase through the medium.

The permeability, absolute permeability, phase permeability, and relative permeability all refer to factors which influence the flow of fluids through a porous medium such as a reservoir rock. Embodiments of the inventive method determine phase permeability by injecting and measuring the penetration of a fluid which has magnetic permeability (e.g., an elevated magnetic permeability). Magnetic permeability is an electromagnetic property which describes the degree of magnetization produced in the material by the application of a magnetic field. To prevent confusion, in this application we will refer to “magnetic permeability” when we mean the electromagnetic property. Otherwise “permeability” will mean a property of porous media related to fluid flow.

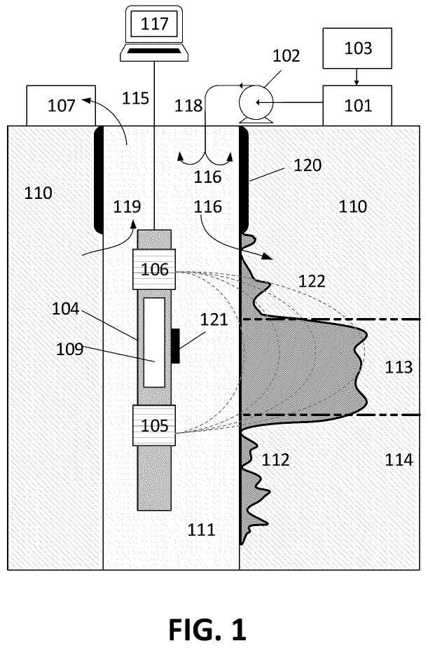

FIG. 1 shows a system for determining the phase permeabilities of a subsurface geological formation 110 in proximity to a wellbore 111. The formation 110 may include a solid matrix (for example, made of grains of silica or calcite) and a pore space within the matrix which is full of hydrocarbons, such as crude oil and natural gas, and/or brine. A system to determine permeability of the geological formation 110 may include surface equipment 101,102,103,107 as well as a downhole tool 104. This surface equipment includes equipment to mix particles with high magnetic permeability into a fluid to form a fluid with elevated magnetic permeability. Fluid vessel 101 holds the fluid. In various embodiments, the fluid may be brine extracted from the well, brine from a different source, an artificially formulated water-based fluid, oil extracted from the well, oil extracted from a different source, and artificially-formulated oil-based fluid. A brine or water-based fluid may be beneficial when desired to measure the phase permeability to brine. An oil or oil-based fluid may be beneficial when desired to measure the phase permeability to oil.

Particle vessel 103 holds magnetic particles (for example, ferrous particles) with a high magnetic permeability which will be added and mixed into the fluid in the fluid vessel 101. The vessel 103 may store magnetic particles, such as magnetic nanoparticles, that are added to the fluid in the fluid vessel 101 to increase the magnetic permeability of the fluid. The magnetic particles may optionally have a coating applied, such as described in U.S. Pat. Nos. 10,273,399, 10,308,865, 10,487,259, and 10,501,682, which are incorporated by reference herein in their entirety. In various embodiments, the mixing of the particles with the fluid may occur at the surface as illustrated in FIG. 1 or may occur downhole within the wireline tool or by a second tool deployed for this purpose, where the tank for storing magnetic particles may be located within the tool rather than at the surface.

FIG. 1 is a well having a wellbore 111 in a geological formation 110 (subterranean formation). A pump 102 acts to develop a pressure in the wellbore 111 which exceeds the pressure far from the wellbore in the formation 110 such that the fluid with elevated magnetic permeability from vessel 101 is forced into the formation 110, causing a portion 112 of the formation 110 near the wellbore to become saturated with the fluid such that this saturated portion of the formation 110 has a higher magnetic permeability than portions that did not become saturated with the fluid. The saturated region 112 extends further from the wellbore in the radial direction in parts of the formation 110 with high permeability 113, and does not extend as far in parts of the formation 110 with low permeability 114. Casing pipe 120 of the wellbore 111 may prevent the fluid from penetrating the formation 110 at certain depths.

The fluid along with the magnetic particles is injected into the wellbore 111, as indicated by arrow 116. The injection may be via a motive device, such as a pump 102. The surface equipment may include the pump 102 to deliver the fluid (or a slurry of the fluid and magnetic particles) from the fluid vessel 101 into the wellbore 111 and thus into the formation 110. The pump 102 may be, for example, a centrifugal pump. The fluid or slurry discharges from the pump 102 though a conduit 118, such as piping or tubing, into the wellbore. The pumping of the fluid through the wellbore may provide pressure (pump head) for penetration of the magnetic particles into the formation 110. The surface equipment may include a return vessel 107 to receive a return 119 of a slurry of fluid and magnetic particles from the formation 110. The return vessel 107 may be a tank to receive the return 119 including fluid and magnetic particles. The return 119 may be produced from the formation 110 through the wellbore to the return vessel 107. The surface equipment may be a fluid or slurry system for injection and withdrawal of fluid and magnetic particles. In various embodiments, the injection pump may be located at the surface or may be located downhole such as within the wireline tool or within a coiled tubing conveyed tool.

A downhole tool 104 may collect data which can be used to determine the extent of the saturated region 112, and from this log the phase permeability of the formation 110 along the wellbore 111. To do so, the downhole tool 104 may have an electronics module or apparatus 109, transmitter 106 antenna (antenna coil), and receiver 105 antenna (antenna coil), and may measure the mutual inductance between the transmitter and receiver coils. In the illustrated embodiment, the downhole tool 104 is depicted disposed in a wellbore 111 within a formation 110. The downhole tool 104 may be lowered into the wellbore from the Earth surface via, for example, a wireline cable 115.

The electronics module 109 may have a hardware processor and memory storing code executed by the processor to operate the downhole tool 104. The memory may store collected data. The data may include measurements of the mutual inductance between the transmitter 106 and receiver 105 coils. The electronics module 109 may transmit data to the Earth surface via a wireline cable 115, wireless communication, or another telemetry system. Alternatively, the electronics module 109 may store the data in its internal memory to be downloaded after the tool is retrieved from the wellbore. A computing system 117 may receive the data from the tool. The computing system 117 may include a processor and memory storing code executed by the processor to process the data. Such processing may include determining the phase permeability of the formation 110 based on measured mutual inductance or self-inductance or other property related to the magnetic permeability of the formation.

The wellbore 111 may be open-hole or may have casing 120. For a cased wellbore 111, the annulus between the casing and the formation may be cemented. The casing and cement may have perforations to allow fluid and particle flow through the cemented casing between the formation 110 and the wellbore 111.

In various embodiments, the portion of the wellbore 11 where the fluid is to be injected may be isolated from the remainder of the wellbore 111 using packers such that the injection pressure is only applied in the desired portion of the wellbore 111. Fluid may be initially produced from a portion of the wellbore to remove mudcake from the borehole wall. The fluid injection may occur during a drill stem test, where the fluid is injected immediately following or during the flow rate testing. In various embodiments, a formation fluid sampling tool may attach to the borehole wall, produce fluid from the formation to remove mudcake, and then perform the fluid injection.

During the injection 116 of the fluid having magnetic particles and during the subsequent production of the return 119 having magnetic particles, the downhole tool 104 may produce a magnetic field 122. The tool 104 may produce the magnetic field 122 via the transmitter 106 antenna through the formation 110 and detect the magnetic field 122 via the receiver 105 antenna. Thus, the mutual inductance may be determined between the transmitter and receiver coils. From the mutual inductance measurement, the extent of invasion 112 of the fluid with elevated magnetic permeability may be determined as the measured mutual inductance changes over time during the injection and withdrawal of fluid with magnetic particles. The downhole tool 104 as an electrical apparatus may measure magnetic permeability (μ) of the geological formation 110 during fluid injection 116 and withdrawal 119. Before, during, and after injection or withdrawal, multiple electromagnetic measurements (images) can be made and captured by the downhole tool 104.

Thus, embodiments provide for a downhole tool 104 and associated surface equipment to measure magnetic permeability in-situ. The sensor array (transmitter 106 antenna and receiver 105 antenna with the electronics module 109) may make an initial measurement or logging run before injection of magnetic particles. This initial measurement may serve as a baseline measurement of local magnetic permeability. As discussed, magnetic particles (e.g., magnetic nanoparticles) may then be injected into the wellbore 111 and dispersed through the formation 110. The sensor array may measure (for example, continually) the local magnetic permeability distribution. The downhole tool 104 may record changes to this measured quantity of magnetic permeability as the magnetic particles travel through the formation 110 and affect the local magnetic permeability surrounding the sensor array. The particle dispersion may then be reversed by producing from the formation 110. The sensor array may continually measure the local magnetic permeability and record changes to this measured quantity over time during the production of particles from the formation 110. By measuring local magnetic permeability during (1) the baseline, (2) the injection of magnetic nanoparticles, and (3) the production of magnetic nanoparticles from the well, the tool sensor array may obtain a set of radial profiles of particle distribution as a function of time. The evolution of magnetic-permeability radial profiles can be a function of permeability. Therefore, by comparing these radial profiles as a function of time, the permeability may be obtained.

The induction transmitter(s) 105 and receiver(s) 106 may be positioned along the tool 104 axis. The electronics module 109 via electrical equipment of the tool 104 may generate an electrical voltage or current waveform to be applied to the transmitter 105 coil. The transmitter 105 may cause a magnetic field to travel through the formation 110, inducing a voltage waveform in the receiver 106 antenna coils. The electronics module 109 may condition and process the signals from receiver 106 antenna coils. The acquired data may be stored in the downhole tool 104 or sent to the Earth surface via telemetry through the wireline cable 115 utilized to lower the tool 104 into the wellbore.

The waveform applied to the transmitting coil may be a sin-wave (sine wave) at a single frequency, a combination of sin-waves at multiple frequencies, or a square-wave with a continuum of frequency content. The downhole tool 104 including its electronics module 109 may utilize single frequency sin-wave, multiple-frequency sin wave, or square-wave transmissions in order to interrogate the magnetic permeability of the surrounding formation.

The downhole tool 104 can be of a transformer-type having at least one receiver 106 antenna coil and at least one transmitter 105 antenna coil or of an inductive type having a single coil (self-inductance), such as with a transmitter 105 antenna but no receiver 106 antenna. A downhole tool 104 of a transformer type has a separate transmitter 105 antenna and receiver 6 antenna as depicted in FIG. 1 and discussed earlier. In other words, the measuring apparatus of the tool 4 may have at least one transmitter 5 antenna and at least one receiver 6 antenna and may measure the mutual inductance between the antennas. Mutual inductance may be the extent to which a time-varying current in the transmitter antenna induces a voltage in the receiver antenna, so it may be determined in one embodiment by applying a time-varying current to the transmitter antenna and measuring the voltage induced in the receiver antenna. The mutual inductance depends on the magnetic permeability of the formation around the tool, such that injecting a fluid with elevated magnetic permeability into the formation causes an increase in the magnetic permeability of the formation where the fluid penetrates. This will result in an increased mutual inductance measured between the transmitter and receiver coils.

In operation, the electromagnetic transmitter 105 antenna radiates a time-varying magnetic field into the formation and induces a time-varying voltage in receiving coils (receiver 105 antenna) which is determined at least in part by the field which has passed through the formation 110. Induced voltage at the receiver 105 antenna coils may depend on electrical and magnetic properties of formation 110. For the transformer type, the downhole tool 104 may have one transmitter 105 antenna and one receiver 106 antenna or may have one active transmitter antenna and multiple simultaneously active receiver antennae, or may have multiple simultaneously active transmitter 105 antennae, for example operating at different frequencies, and one or multiple simultaneously active receiver 106 antennae.

The mutual inductance between a pair of transmitter and receiver coils is not equally sensitive to magnetic permeability changes at all depths or at all radial distances from the axis of the tool. Rather, the sensitivity is greatest near the depth of the coils. The sensitivity is a function of radial distance into the formation that depends on the separation of the coils along the axis of the tool. Thus, by measuring the mutual inductance between the coils with different separation distances along the tool axis, the magnetic permeability at different depths into the formation can be determined, thus the magnetic permeability at different radial distances from the wellbore axis can be measured. In one embodiment, there are multiple pairs of transmitter and receiver coils with different separations between transmitter and receiver coils, such that measuring the mutual inductance between these pairs of coils allows the magnetic permeability to be determined as a function of radial distance from the tool axis. In one embodiment, a coil can be configured by the electronics inside the tool to function as a transmitter at one time and a receiver at a different time to reduce or minimize the number of coils required to achieve a desired set of coil separations.

In one embodiment, the downhole tool 104 may be of an inductive type, where a single coil functions as both transmitter and receiver at the same time. In this case, a time-varying voltage is applied to the coil and the time-varying current produced through the same coil are measured to determine the self-inductance of the coil. This self-inductance depends on the magnetic permeability of the formation around the tool, such that injecting a fluid with elevated magnetic permeability results in an increase in the self-inductance of the coil. The self-inductance of the coil is not equally sensitive to magnetic permeability changes at all locations in the formation. Rather it is most sensitive to magnetic permeability changes at the depth of the coil, and at radial distances that depend on the length of the coil. A longer coil projects its magnetic field further into the formation and is therefore sensitive to magnetic permeability changes deeper in the formation. In one embodiment, the tool contains multiple coils of different length to probe the magnetic permeability at different distances into the formation. In another embodiment, the tool contains a single long coil, where the electronics inside the transmitter may connect to and energize longer or shorter segments of the same coil to achieve different sensitivity depths without requiring multiple coils.

The receiver and transmitter coils of the transformer-type tool and the single coil of the inductive-type tool may be solenoids with a constant winding density or constant number of turns per unit length along the coil length, or they may have varying densities of windings along their length, or may be made up of smaller solenoid segments connected in series and positioned at uniform or non-uniform spacing along the axis of the tool. These different coil geometries can be selected to achieve the desired magnetic field strength at different axial and radial distances from the center of the tool, which will produce different sensitivities in the axial and radial direction to changes in magnetic permeability, sensitivity being greater where the magnetic field is stronger.

These solenoidal coils wound around the axis of the tool are equally sensitive to permeability changes at all radial directions from the tool. The receiver and transmitter coils may have turns around an axis perpendicular to the axis of the tool to sense magnetic permeability selectively in one radial direction.

The propagation of electromagnetic waves in any medium is determined by the conductivity, permittivity, and magnetic permeability of the medium. The inventors recognized that the injection of a fluid into a formation will cause changes in the conductivity and permittivity of the formation by at least two mechanisms: the injected fluid will partially replace the mixture of hydrocarbons and brine originally in the pore space and the displaced mixture will push through the formation ahead of the injected fluids, changing the water/oil saturation even beyond the reach of the injected fluids. The degree to which the pore fluids are displaced and the alterations in saturation produced by the displaced fluids ahead of the injected fluids are confounding variables that would make it difficult to determine the penetration of an injected fluid which differed from the pore fluids in its conductivity or permittivity. The inventors recognized that the existing pore fluids are non-magnetic having a magnetic permeability exactly equal to that of free space. Thus, any measured change in the magnetic permeability of the formation can only indicate the presence of injected fluid with enhanced magnetic permeability. Although the change in magnetic permeability achievable by adding magnetic particles to the injected fluid is small (roughly 1%), there is generally no other possible cause for magnetic permeability change downhole other than the injected fluid. Thus in embodiments, the injected fluid has an elevated magnetic permeability.

The mutual inductance between transmitter and receiver coils or the self-inductance of a single coil are influenced by the conductivity of the medium due to the induction of eddy currents and by the magnetic permeability of the medium. The inventors recognized that the effect of eddy currents on the mutual inductance or self-inductance could be made negligibly small by reducing the frequency of the measurement. For coil separations up to several meters and typical conductivities of downhole rocks, a measurement frequency below 1 kHz is essentially unaffected by conductivity changes that might be caused by fluid injection. This ability to measure magnetic permeability at a frequency where there was no confounding effect of conductivity changes is another reason why injecting a fluid with elevated magnetic permeability is implemented in embodiments.

In another embodiment, the assembly or tool 104 may measure magnetic permeability and electrical conductivity by using measurement frequencies that are high enough to sense both effects, or one higher frequency which sees both effects and one lower frequency which sees only the effect of magnetic permeability. Conductivity may be measured in this way to minimize or remove the effect of the formation fluid changes during magnetic permeability measurement.

Once the mutual inductance between the coils is measured for at least one frequency and coil separation or the self-inductance of a coil is measured for at least one frequency and coil length, the magnetic permeability of the formation can be found by solving an inverse problem. In one embodiment, the region around the tool is divided into N smaller cells which are assumed to have a constant permeability. In one embodiment, the region is divided into cells by surfaces at various radii from the borehole, forming cells which are cylindrical cells all having the same axis as the borehole, for example, with each cell having the same thickness or cells having thicknesses that increase exponentially or proportionally with their radii. The M mutual inductances between all pairs of coils for a transformer type tool and/or the M self-inductances of all coils for an induction type tool are computed in numerical simulation for a background case where the magnetic permeability in all cells equals the permeability of free space. If P frequencies are used in the measurement, then the simulation is repeated for each frequency producing M*P measurements. Then the magnetic permeability of each of the N cells is increased slightly in turn, for example by dp=0.001*μ₀ where μ₀ is the magnetic permeability of free space, and the M*P measurements are recalculated and the measurements in the unincreased (baseline) case are subtracted to provide M*P measurement differences. These M*P measurement differences are divided by dp and placed in the rows of a M*P×N matrix C, which relates a perturbation in the mutual inductance in any combination of the N cells to the corresponding change in the measurements:

y=Cx

Where C is the change in magnetic permeability and y is the change in the measured mutual inductances. When the difference between the measured mutual inductances and the baseline mutual inductances are found in the field, an estimate \hat{x} of the magnetic permeability variations (from the baseline or free space permeability) in the cells around the borehole can be found in one embodiment as the least squares inverse,

\hat{x}=(C^{H}C)⁻¹C^{H}y

Where H indicates the Hermetian or complex conjugate transpose. This allows the mutual inductance changes in C to be complex valued, allowing for complex mutual inductances where the imaginary part would represent a resistive component due to circuit or coil resistances or losses in the medium due to eddy currents). Optionally, a N×N covariance matrix P can be added inside the inverse to regularize the inverse, that is, to prevent it from being unstable when C^{H}C is not full rank or has eigenvalues which vary by many orders of magnitude. In one embodiment, P=Iσ² where I is the identity matrix, and σ² is a constant that may be determined experimentally or may be the prior variance of the mutual inductance variations.

\hat{x}=(C^{H}C+P)⁻¹C^{H}y

If the magnetic permeability of the fluid is μ_{f} and the background magnetic permeability of the formation before injection was μ₀ and magnetic permeability as a function of radial distance is μ(r), r_{w} is the radius of the wellbore, and rₘₐₓ is a radius beyond which there is no significant change in magnetic permeability, then the flow rate per unit depth of the ith phase can be found as the total volume of injected fluid divided by the duration of the injection ΔT,

$$\frac{{q}_{i}}{h} = \frac{2 π}{Δ T} {\int }_{{r}_{w}}^{{r}_{max}} \frac{μ ( r ) - {μ}_{0}}{{μ}_{f} - {μ}_{0}} r d r$$

To determine the phase permeability of the formation, a pressure transducer 121 is provided in the wireline tool 4 preferably at the depth where the injection will take place, for example, it could be placed between the coils 5 and 6. The pressure transducer measures an injection pressure P_{I} at the injection depth in the wellbore during the injection and a formation pressure P_{W} before or after the injection when there is no fluid moving in or out of the reservoir. Using the inflow performance relationship for the well, preferably for a transient flow where the pressure effect of the injection has not reached the boundaries of the formation, we have the phase permeability for the ith phase in millidarcies:

$${k}_{i} = - \frac{162.6 {μ}_{i}}{( {P}_{W} - {P}_{I} )} [ log ( \frac{{k}_{i} t}{ϕ {μ}_{i} {r}_{w}^{2}} ) - 3.23 + 0.87 s ] \frac{{q}_{i}}{h}$$

Where μᵢ is the viscosity of the ith phase in centipoise (cp), t is the time of the injection in hours, ϕ is the volume fraction of injected fluid in the rock near the wellbore, which can be taken as a volume-weighted average over those distances r where the formation is substantially full of injected fluid:

$$ϕ ( r ) = \frac{μ ( r ) - {μ}_{0}}{{μ}_{f} - {μ}_{0}}$$

And s is the skin factor, which indicates the extent to which there is a low permeability skin on the face of the formation which prevents fluid flow.

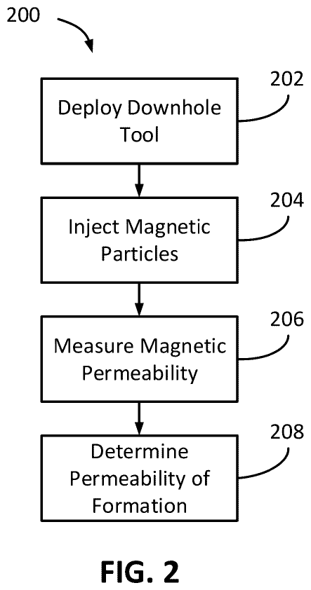

FIG. 2 is a method 200 to determine the permeability (such as the phase permeability or the absolute permeability) of a geological formation (subterranean formation). The geological formation may be a formation in the Earth crust. The formation may have hydrocarbons in the pore space and thus be labeled as a hydrocarbon-bearing formation.

At block 202, the method includes deploying a downhole tool into a wellbore in the geological formation. The downhole tool includes a transmitter and a receiver. The downhole tool may include an electronics module to direct operation of the downhole tool. The deploying of the downhole tool may include lowering the downhole tool into the wellbore via a wireline. The method may include calibrating the downhole tool in air outside of the wellbore before lowering the downhole tool into the wellbore.

At block 204, the method includes injecting magnetic particles through the wellbore into the geological formation. The injecting may involve pumping fluid having the magnetic particles from through Earth surface through the wellbore into the geological formation. For an open-hole wellbore with no casing at the depth of injection, the fluid having the magnetic particles may flow through the wellbore directly into the geological formation. For a wellbore with a casing or cemented casing, the fluid having the magnetic particles may flow through the wellbore and through perforations in the casing into the geological formation. In one embodiment, the magnetic particles may be carried by an oil-based fluid to measure the phase permeability for oil. In one embodiment, the particles may be carried by a water-based fluid to measure the phase permeability for brine.

At block 206, the method includes measuring, via the downhole tool, magnetic permeability of the geological formation having the injected magnetic particles. The method may also include measuring, via the downhole tool, magnetic permeability of the geological formation before injecting the magnetic particles as a baseline or reference measurement. In some implementations, such prior measuring may be a form of calibration of the downhole tool.

The method may include emitting a magnetic field into the geological formation from the transmitter. This may be employed by the downhole tool in measuring the magnetic permeability. Further, the measuring of magnetic permeability may include sensing the magnetic field at the receiver of the downhole tool. The downhole tool via the measuring (and the electronics module) may obtain a set of radial profiles into the geological formation from the tool as a function of time. In certain embodiments, the measuring of the magnetic permeability includes reducing effect of electrical conductivity of the geological formation on the measuring of the magnetic permeability. Such may be implemented via the transmitter, the electronics module, and also a computing system at the Earth surface (local or remote). To reduce effect of a confounding parameter, such as conductivity, the method may specify the frequency of the emitted electromagnetic radiation or specify timing of the magnetic-permeability measurement, or both.

At block 208, the method includes correlating, via a hardware processor, the permeability with the magnetic permeability to determine the permeability of the geological formation. The evolving radial profiles of magnetic permeability may be a function of permeability. Therefore, the permeability can be determined or calculated. For instance, by comparing the radial profiles as a function of distance or time, the permeability may be obtained. The processor may be in the electronics module or in a computing system at the Earth surface (local or remote).

An embodiment is a method to determine the permeability downhole of a formation surrounding a borehole. The method includes deploying a downhole tool into the borehole at a specific depth and injecting a fixed amount of magnetic-permeability doped fluid into the formation around the downhole tool. The method includes measuring, via the downhole tool, a post-injection radial profile of magnetic permeability of the formation around the downhole tool after injecting the fixed amount of magnetic-permeability doped fluid. The method includes withdrawing fluid from the formation and measuring, via the downhole tool, a post-production radial profile of magnetic permeability of the formation around the downhole tool after withdrawing a fixed amount of fluid from the formation. The method includes correlating a difference between the post-production radial profile and the post-injection radial profile with permeability of the formation around the downhole tool. The method may include measuring, via the downhole tool, a radial profile of magnetic permeability of the formation around the downhole tool during the injecting of the fixed amount of magnetic-permeability doped fluid. Thus, the downhole tool or remote computer may determine the permeability correlative with a time rate of change of the radial profile of the magnetic permeability during the injecting of the fixed amount of magnetic-permeability doped fluid. The method may include measuring, via the downhole tool, a radial profile of magnetic permeability of the formation around the downhole tool during the withdrawal of the fixed amount of fluid from the formation. Thus, the downhole tool or remote computing system may determine the permeability of the formation around the downhole tool as correlative with a time rate of change of the radial profile of the magnetic permeability during the withdrawal. The method may also determine the permeability correlative with a time rate of change of the radial profile of the magnetic permeability over time during the combination of the injecting and subsequent withdrawal.

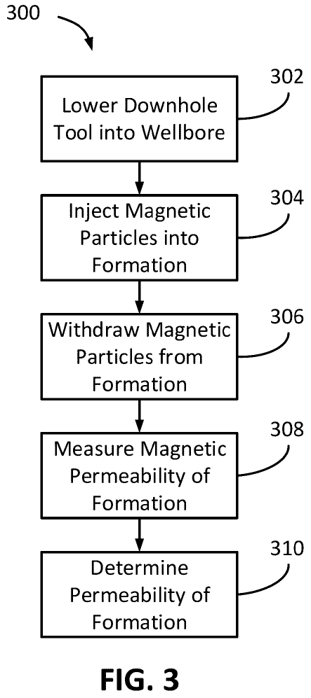

FIG. 3 is a method 300 to determine permeability of a geological formation in the Earth crust. At block 302, the method includes lowering a downhole tool into a wellbore in the formation. The downhole tool has a transmitter and a receiver. In some embodiments, the downhole tool has an electronics module to facilitate managing operation of the downhole tool. The downhole tool may be lowered into the wellbore via a wireline or coiled tubing.

At block 304, the method includes injecting magnetic particles through the wellbore into the formation. The injecting may include pumping fluid having the magnetic particles from the Earth surface through the wellbore into the formation. The method may include holding or storing fluid and magnetic particles in one or more vessels at the Earth surface.

At block 306, the method includes withdrawing the magnetic particles from the formation through the wellbore. The withdrawing of the magnetic particles may include receiving the magnetic particles from the formation through the wellbore to a vessel at the Earth surface. In one implementation, the withdrawing involves pumping fluid from the Earth surface through the wellbore into the formation to wash or displace the magnetic particles from the formation to a second wellbore. In another implementation, the withdrawing involves relying on formation pressure to produce (withdraw) the magnetic particles from the formation to the wellbore in which the downhole tool is disposed.

At block 308, the method includes measuring magnetic permeability of the formation via the downhole tool during injecting the magnetic particles and during withdrawing the magnetic particles. The measuring may involve emitting electromagnetic radiation waves from the transmitter, such as transmitter coil or coils, into the formation. If so, the measuring may also include receiving the electromagnetic radiation waves at the receiver such as at a receiver coil(s). The method may include measuring magnetic permeability of the formation via the downhole tool prior to injecting the magnetic particles. Also, the method may include calibrating the downhole tool in-air prior to lowering the downhole tool into the wellbore.

At block 310, the method includes determining, via a hardware processor, the permeability of the formation with respect to the measured magnetic permeability. For instance, the method may determine the permeability as a function of the magnetic permeability. The method may determine, via the processor, the permeability correlative with a profile of the magnetic permeability. The evolution of magnetic permeability radial profiles can be a function of permeability. By mapping the radial distribution of magnetic permeability and how the magnetic permeability changes during injection and production (withdrawal) of magnetic particles (for example, nanoparticles), the local-formation permeability can be obtained or measured in-situ.

Thus, certain embodiments relate to determining formation permeability around the wellbore by injecting fluid loaded with magnetic particles (for example, ferroelectric particles) into the formation and measuring the change in magnetic permeability radially surrounding the tool during injection and withdrawal of the fluid. A downhole sensor array measures the radial distribution of magnetic permeability by sensing changes in the response of sensors such as a series of transmitter and receiver coils. By mapping the radial distribution of magnetic permeability and how the magnetic permeability changes during injection and production of magnetic nanoparticles, the local-formation permeability can be obtained or measured in-situ.

To determine permeability downhole, the downhole-tool sensor array (transmitter and receiver coils) may make a baseline measurement of magnetic permeability of the geological formation before injection of magnetic particles. During injection of magnetic particles into the wellbore and dispersion through the formation, the sensor array may measure the magnetic permeability distribution and record changes to this measured distribution as the particles travel through the formation. The particle dispersion may then be then reversed by producing from the formation. The sensor array measures (for example, continually) the local magnetic permeability and records changes to this measured quantity over time. By measuring magnetic permeability during the baseline, injection of magnetic particles, and production of magnetic particles from the formation, the sensor array may obtain a set of radial profiles as a function of time. The evolving radial profiles of magnetic permeability may be a function of permeability and thus indicate permeability which therefore can be determined or calculated.

An embodiment is a system to determine the permeability downhole of a geological formation surrounding a borehole. The system includes a downhole tool to be deployed at a specified depth in a wellbore to measure magnetic permeability of the formation surrounding the downhole tool as a function of radial depth. The radial depth may be the radial distance from a longitudinal axis of the wellbore or from the longitudinal axis of the deployed downhole tool. The system includes a magnetic-permeability doped fluid to diffuse through the formation surrounding the downhole tool. The magnetic-permeability doped fluid may also be labeled as a magnetic doped fluid. The magnetic-permeability doped fluid may be fluid having magnetic particles. The fluid (for example, water or hydrocarbon) may be include (doped with) magnetic particles. The system to determine permeability includes a surface system (for example, the aforementioned associated surface equipment) having a pump to inject the magnetic-permeability doped fluid through the wellbore into the formation. The surface system includes a vessel to withdraw the magnetic-permeability doped fluid from the formation through the wellbore. A surface system may inject magnetic-permeability doped fluid into the formation surrounding the downhole tool through a different wellbore than the wellbore where the downhole tool is deployed. A surface system may produce the magnetic-permeability doped fluid from the formation through a different wellbore than the wellbore where the downhole tool is deployed.

In implementations, the downhole tool includes a transmitter having electronics and coils to transmit electromagnetic waveforms through the formation in a radial direction from a longitudinal axis of the wellbore and the downhole tool. The downhole tool includes a receiver having electronics and receiving coils to receive the electromagnetic waveforms through from the transmitter the formation and to normalize the electromagnetic waveforms. The downhole tool includes processor electronics to determine penetration distance of the magnetic-permeability doped fluid in a radial direction from a longitudinal axis of the wellbore and downhole tool as a function of time. The process electronics may correlate a time rate of change of magnetic permeability in the radial direction with permeability of the formation. The electromagnetic waveform may have a sine shape, a square shape, or a multi-waveform shape.

Some embodiments relate to permeability evaluation of a geological formation (having hydrocarbon) in the Earth by measuring formation magnetic permeability and/or electric conductivity via a downhole tool at various frequencies and distances between receiver and transmitter coils of the downhole tool. The changing of formation magnetic permeability and conductivity is sensed via a magnetic field traveling through the formation and induced responsive voltage in the receiver coils. Parameters that may affect receiver voltage induced by the transmitter include: coil configuration, number of turns, material of the tool, and transmitter output power. Certain embodiments measure electromagnetic or magnetic permeability and conductivity at various frequencies and distances between receiver and transmitter coils.

An embodiment is a system to determine permeability of a hydrocarbon formation in Earth. The system includes a downhole tool to be lowered into the wellbore in the hydrocarbon formation to measure magnetic permeability of the hydrocarbon formation. The downhole tool includes a transmitter to emit electromagnetic waves into the hydrocarbon formation. The system includes surface equipment at the Earth surface adjacent a wellbore to inject magnetic particles through the wellbore into the hydrocarbon formation. In certain implementations, the downhole tool has a receiver to sense the electromagnetic waves to measure the magnetic permeability. The system may have a hardware processor and memory storing code executable by the hardware processor to correlate the permeability with the magnetic permeability. In some implementations, the downhole tool has an electronics module having the hardware processor and the memory. The system may also include a computing system having the hardware processor and the memory.

Another embodiment is a system to determine permeability of a geological formation. The system includes surface equipment at the Earth surface adjacent a wellbore to inject fluid having magnetic particles through the wellbore into the geological formation. The system includes a downhole tool to be lowered into the wellbore in the geological formation to measure magnetic permeability of the geological formation. The downhole tool has a transmitter to emit electromagnetic radiation into the geologic formation and a receiver to sense the electromagnetic radiation. The downhole tool may have an electronics module to facilitate operation of the downhole tool. In implementations, the surface equipment includes a pump to inject the fluid having the magnetic particles.

Yet another embodiment is a downhole tool to determine permeability of a geological formation. The downhole tool has a coupling for wireline to lower the downhole tool into a wellbore in the geological formation. The coupling may include a loop, clamp, bolting, or connector. The downhole tool has a transmitter (for example, with a coil or coils) to emit electromagnetic radiation waves into the geological formation. The downhole tool has a receiver (for example, with a coil or coils) to sense the electromagnetic radiation waves for the downhole tool to measure magnetic permeability of the geological formation. The downhole tool includes an electronics module to facilitate operation of the downhole tool and to provide data of the measure magnetic permeability for determination of the permeability. The electronics module may have a processor and memory storing code executed by the processor to implement features. In certain implementations, the electronics module correlates the data with permeability to determine the permeability of geological formation. In some implementations, the electronics module is configured to provide the data to a computer at an Earth surface near the wellbore or remote from the wellbore. In one implementation, the electronics module in operation directs the transmitter to emit the electromagnetic radiation waves at a specified frequency to reduce effect of conductivity of the geological formation on the measure of the magnetic permeability.

What is claimed is:

1. A system to determine permeability of a downhole formation surrounding a borehole, comprising:
a downhole tool to be deployed at a specified depth in a wellbore to measure magnetic permeability in a region of a formation surrounding the downhole tool;
magnetic-permeability doped fluid to push into the formation surrounding the downhole tool; and
a pumping system comprising a pump to inject the magnetic-permeability doped fluid into the formation; and
a pressure sensor to measure pressure in the wellbore while the magnetic-permeability doped fluid is injected.

2. The system of claim 1, wherein the pumping system injects the magnetic-permeability doped fluid into the formation surrounding the downhole tool through a different wellbore than the wellbore where the downhole tool is deployed.

3. The system of claim 1, wherein the pumping system produces the magnetic-permeability doped fluid from the formation through a different wellbore than the wellbore where the downhole tool is deployed.

4. The system of claim 1, wherein the downhole tool comprises:
a transmitter comprising electronics and coils to produce a time-varying magnetic field extending into the formation in a radial direction from a longitudinal axis of the wellbore and the downhole tool;
a receiver comprising electronics and receiving coils to measure the time-varying magnetic field produced by the transmitter; and
processor electronics to determine penetration distance of the magnetic-permeability doped fluid in a radial direction from a longitudinal axis of the wellbore and downhole tool as a function of time and to relate time rate of change of magnetic permeability in the radial direction to the permeability of the formation.

5. The system of claim 4, wherein an electrical waveform applied to a transmitter coil of the transmitter has a sinusoidal shape, a square shape, or a multi-waveform shape.

6. A method to determine permeability downhole of a geological formation surrounding a borehole, comprising:
deploying a downhole tool into the borehole at a specific depth;
measuring, via the downhole tool, a baseline radial profile of magnetic permeability of the geological formation around the downhole tool;
injecting a fixed amount of magnetic-permeability doped fluid into the geological formation around the downhole tool;
measuring, via the downhole tool, a post-injection radial profile of magnetic permeability of the geological formation around the downhole tool after injecting the fixed amount of magnetic-permeability doped fluid;
comparing the baseline radial profile with the post-injection radial profile to determine a difference between the post-injection radial profile and the baseline radial profile; and
calculating the permeability of the geological formation around the downhole tool utilizing the difference between the post-injection radial profile and the baseline radial profile.

7. The method of claim 6, comprising measuring, via the downhole tool, a radial profile of magnetic permeability of the geological formation around the downhole tool after injecting of the fixed amount of magnetic-permeability doped fluid.

8. A system to determine permeability of a geological formation, comprising:
a downhole tool to measure magnetic permeability of the geological formation;
a pump to inject fluid having magnetic particles through a first wellbore into the geological formation; and
a vessel to receive fluid having magnetic particles withdrawn from the formation through a second wellbore.

9. The system of claim 8, wherein the second wellbore is the first wellbore.

10. The system of claim 8, wherein the downhole tool comprises:
a transmitter comprising coils to emit electromagnetic waveforms into the geological formation;
a receiver comprising coils to receive the electromagnetic waveforms emitted from the transmitter into the geological formation; and
a processor to determine penetration distance of the magnetic particles into the geological formation in a radial direction from a longitudinal axis of the downhole tool as a function of time.

11. The system of claim 10, wherein the processor to correlate a time rate of change of magnetic permeability in the radial direction with permeability of the geological formation.

12. A method to determine permeability of a geological formation, comprising:
deploying a downhole tool into a wellbore in the geological formation, the downhole tool comprising a transmitter;
injecting magnetic particles into the geological formation; and
measuring, via the downhole tool, magnetic permeability of the geological formation having the magnetic particles as injected.

13. The method of claim 12, wherein measuring the magnetic permeability comprises emitting, via the transmitter, electromagnetic waves into the geological formation.

14. The method of claim 12, comprising correlating, via a processor, the permeability with the magnetic permeability to determine the permeability of the geological formation.

15. The method of claim 12, wherein measuring comprises reducing effect of electrical conductivity of the geological formation on the measuring of the magnetic permeability.

16. The method of claim 12, wherein measuring comprises, receiving at a receiver of the downhole tool, electromagnetic waves emitted by the transmitter into the geological formation.

17. The method of claim 12, wherein injecting comprises pumping fluid having the magnetic particles into the geological formation.

18. The method of claim 12, comprising measuring, via the downhole tool, the magnetic permeability of the geological formation prior to injecting the magnetic particles into the geological formation.

19. A method to determine permeability of a formation in Earth crust, comprising:
lowering a downhole tool into a wellbore in the formation, the downhole tool comprising a transmitter and a receiver;
injecting magnetic particles through the wellbore into the formation;
withdrawing the magnetic particles from the formation through the wellbore; and
measuring magnetic permeability of the formation via the downhole tool during injecting the magnetic particles and during withdrawing the magnetic particles.

20. The method of claim 19, comprising measuring magnetic permeability of the formation via the downhole tool prior to injecting the magnetic particles.

21. The method of claim 19, comprising calibrating the downhole tool in-air prior to lowering the downhole tool into the wellbore.

22. The method of claim 19, wherein injecting comprises pumping fluid having the magnetic particles from an Earth surface through the wellbore into the formation.

23. The method of claim 22, wherein withdrawing comprises receiving the magnetic particles from the formation through the wellbore to a vessel at surface adjacent the wellbore.

24. The method of claim 22, wherein withdrawing comprises allowing produced fluid to displace the magnetic particles from the formation.

25. The method of claim 22, wherein measuring comprises:
emitting electromagnetic radiation waves from the transmitter into the formation; and
receiving the electromagnetic radiation waves at the receiver.

26. The method of claim 19, comprising determining, via a processor, the permeability as a function of the magnetic permeability.

27. The method of claim 19, comprising determining, via a processor, the permeability correlative with a profile of the magnetic permeability.

28. A downhole tool to be disposed in a wellbore to determine permeability of a geological formation, comprising:
a transmitter to emit electromagnetic radiation waves into the geological formation;
a receiver to sense the electromagnetic radiation waves for the downhole tool to measure magnetic permeability of the geological formation; and
an electronics module comprising a processor and memory storing code executable by the processor to facilitate operation of the downhole tool and to provide data of the measured magnetic permeability for determination of the permeability.

29. The downhole tool of claim 28, wherein the electronics module to direct the transmitter to emit the electromagnetic radiation waves at a specified frequency to reduce effect of electrical conductivity of the geological formation on the measure of the magnetic permeability.

30. The downhole tool of claim 28, wherein the electronics module to provide the data to a computer at surface near the wellbore or remote from the wellbore.

31. The downhole tool of claim 28, wherein the electronics module to correlate the data with the permeability to determine the permeability of the geological formation.
